(19) United States
(12) Patent Application Publication
(10) Pub. No.: US 2018/0257212 A1
(43) Pub. Date: Sep. 13, 2018

(54) MULTI-TOOL DEVICE

(71) Applicant: Brim & Hickson, LLC, McKinney, TX (US)

(72) Inventors: Nancy Preston, McKinney, TX (US); Arthur Lloyd Brim, McKinney, TX (US)

(21) Appl. No.: 15/912,255

(22) Filed: Mar. 5, 2018

Related U.S. Application Data
(60) Provisional application No. 62/467,977, filed on Mar. 7, 2017.

(51) Int. Cl. B25F 1/00; B25G 1/10

(52) U.S. Cl. CPC B25F 1/00; B43L 7/00; B25G 1/10

(57) ABSTRACT

Aspects of the disclosure relate to a multi-tool device including a main body forming a handle, a bottle opener disposed on one end of the handle and a claw disposed on the other end of the handle. The multi-tool device is formed of a single piece of material and may include additional tools, such as a magnet cavity, strike points, pry ledge, utility holes, and a male adaptor configured to allow the attachment of the multi-tool device to other tools or accessories containing a female adaptor. The claw may include a curved portion that is split down a middle thereof to form a V-shaped opening within which a cutter may be formed. The handle may further include a ruler with metric and/or standard units of distance.

### PRIORITY CLAIM

This application claims priority to and the benefit of Provisional Patent Application No. 62/467,977 filed in the U.S. Patent and Trademark Office on Mar. 7, 2017, the entire contents of which are incorporated herein by reference as if fully set forth below in their entirety and for all applicable purposes.

### TECHNICAL FIELD

The technology discussed below relates generally to tools, and in particular, to a tool providing multiple functions.

### INTRODUCTION

A tool is a device used to carry out a particular function. Examples of tools may include, but are not limited to, hammers, winches, scrapers, crowbars, knives, drills, screwdrivers, pliers, chisels, ratchets, wrenches, cutters, bottle openers, rulers, and stud finders. Consumers typically purchase a separate tool for each function. However, tools that perform more than one function are currently available.

An example of a device providing multiple hand-held functions is described in U.S. Pat. No. 7,036,952, in which a housing of the tool includes a plurality of compartments, each maintaining a different hand tool, such as a hatchet, digging tool, flashlight, knife, and saw. Since most of the hand tools are at least partially recessed into the housing or body of the device, the consumer must manually rotate or release a recessed hand tool in order to gain access to that hand tool. In some instances, the consumer may be required to remember where each hand tool is located within the housing so as to not rotate or release the wrong hand tool. Therefore, a multi-tool design that provides easier access to each of the tools may be desirable.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure relate to a multi-tool device including a main body forming a handle, an opener, such as a bottle opener, disposed on one end of the handle and a claw disposed on the other end of the handle. The multi-tool device is formed of a single piece of material and may include additional tools, such as a magnet cavity configured to receive a magnet, strike point(s), pry ledge, utility hole(s), and a male adaptor configured to allow the attachment of the multi-tool device to other tools or accessories containing a female adaptor. In some examples, the handle, the opening, and the claw may be collectively formed utilizing a mold of the single piece of material.

The claw may include a curved portion that is split down the middle thereof to form a V-shaped opening within which a cutter may be formed. In some examples, the male adaptor may be disposed on a back surface of the handle proximal to the claw to provide leverage for the claw.

The handle may further include a ruler with metric and/or standard units of distance. In some examples, the handle may further include a plurality of indentions on at least one surface thereof demarking units of distance. For example, a standard ruler may be formed within a front surface of the handle, while a metric ruler may be formed within a back surface of the handle.

In some examples, the handle may have a rectangular shape and an opening of the bottle opener may have a trapezoidal shape. In some examples, the opener includes a set of parallel sides and a set of non-parallel sides. A first side of the set of parallel sides may be coupled to the handle and include a single external surface facing the opening. In some examples, the single external surface may function as a pry ledge. A second side of the set of parallel sides may be opposite the first side and separated from the first side by the opening. The second side may further include an internal surface facing the opening and an external surface opposite the internal surface. In some examples, the external surface of the second side may function as a scraper ledge. The opener may further include a set of corners at respective ends of the second side. In some examples, each corner may function as a striking point configured to strike another object.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a perspective view of a multi-tool device according to some aspects of the present disclosure.

FIG. 2 is a front view of the multi-tool device according to some aspects of the present disclosure.

FIG. 3 is a cross-sectional view of the multi-tool device according to some aspects of the present disclosure.

FIG. 4 is a back view of the multi-tool device according to some aspects of the present disclosure.

FIG. 5 is an expanded view of a portion of the multi-tool device according to some aspects of the present disclosure.

FIG. 6 is an expanded view of another portion of the multi-tool device according to some aspects of the present disclosure.

FIG. 7 is an expanded view of another portion of the multi-tool device according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

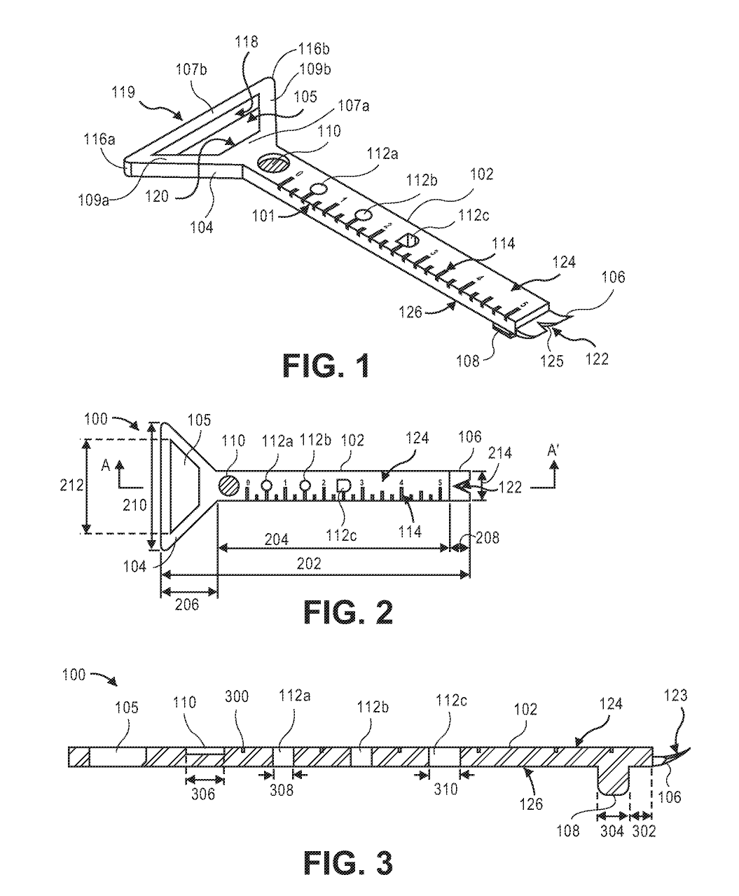

FIG. 1 is a perspective view of a multi-tool device 100 according to some aspects of the present disclosure. The multi-tool device 100 may be utilized to carry out a number of different functions. By way of example, but not limitation, the multi-tool device 100 may be utilized as a security device, winch, bottle opener, scraper, peeler, stud finder, wrench, ruler, hammer, nail puller, wire stripper/cutter, and/or glass breaker.

The multi-tool device 100 includes a main body 101 forming a handle 102, an opener 104 disposed on one end of the handle 102 and a claw 106 disposed on the other end of the handle 102. The handle 102 has a rectangular shape with flat surfaces on all sides. The handle 102 provides stability during operation of the multi-tool device 100.

The opener 104 includes an opening 105 configured to enable the multi-tool device 100 to function as a bottle opener to remove caps or lids or as a key (security device) to provide a locking/un-locking mechanism. In the example shown in FIG. 1, the opener 105 and the opening 105 each have a trapezoidal shape.

Thus, the opener 104 includes a set of parallel sides 107a and 107b and a set of non-parallel sides 109a and 109b. One of the parallel sides (e.g., side 107a) is coupled to the handle 102 at one end thereof, and as such, includes only a single external surface 120 facing the opening 105. In some examples, the external surface 120 may function as a pry ledge to aid in the removal of caps and/or lids. In addition, the pry ledge 120 may further enable leverage to be applied to another object.

The other parallel side (e.g., side 107b) opposite parallel side 107a is separated from parallel side 107a by the opening 105 and includes both an internal surface 118 facing the opening 105 and an external surface 119 opposite the internal surface 118. In some examples, the external surface 119 may function as a scraper ledge that may be used to scrape, peel, or spread.

The opener 104 may further include a set of corners 116a and 116b disposed at respective ends of the parallel side 107b. In particular, each corner 116a and 116b couples the parallel side 107b to one of the non-parallel sides 109a and 109b, respectively. In some examples, each of the corners 116a and 116b may be a striking point configured to strike another object. For example, each of the striking points 116a and 116b may be used as a hammer or a glass breaker.

The claw 106 includes a curved portion 123 that is split substantially down the middle thereof to form an opening 122 having a V-shape. In some examples, the claw 106 provides the function of a nail puller. In other examples, the claw 106 enables the multi-tool device to be utilized as a pry bar or crowbar. In addition, a cutter 125 may be disposed within the opening 122 of the claw 106. In particular, the cutter 125 may be formed on the inner surfaces of the opening 122 of the claw 106. In some examples, the cutter 125 may be utilized to cut or strip wire, string and/or line.

The multi-tool device 100 may further include a male adaptor 108 disposed on a back surface 126 of the handle 102. In the example shown in FIG. 1, the male adaptor 108 is disposed proximal to the claw 106 to provide leverage for the claw 106. In other examples, the male adaptor 108 may be disposed on a different section of the handle 102. In some examples, the male adaptor 108 is configured to engage with a female adaptor to enable the multi-tool device 100 to be attached to other tools and/or accessories.

The multi-tool device 100 may further include a magnet cavity 110 formed in a front surface 124 of the handle 102. The magnet cavity 110 may be configured to receive and secure a magnet. In some examples, when a magnet is inserted into the magnet cavity 110, the multi-tool device 100 may function as a stud or nail finder. In other examples, when a magnet is inserted into the magnet cavity 110, the multi-tool device 100 may itself function as a magnet.

The multi-tool device 100 may further include a plurality of utility holes 112a, 112b, and 112c aligned along a length of the handle 102. Each of the holes 112a, 112b, and 112c may extend completely through the handle 102. In the example shown in FIG. 1, two of the holes 112a and 112b have are circular holes, while another hole 112c includes two rounded corners with one straight edge opposite the two rounded corners. In some examples, the holes 112a, 112b, and 112c may enable rope or string to be inserted therethrough to convert the multi-tool device 100 to a winch. In other examples, the utility holes 112a, 112b, and 112c may be utilized to secure or stabilize the multi-tool device 100.

The multi-tool device 100 may further include a ruler 114 formed within at least one surface of the handle 102. In the example shown in FIG. 1, a standard ruler 114 is formed on the front surface 124 of the handle 102. Although not shown, a different ruler, such as a metric ruler, may be formed on the back surface 126 of the handle 102.

In some examples, the handle 102, opener 104, and claw 106 may be formed of a single piece of material. For example, the handle 102, opener 104, and claw 106 may be collectively formed utilizing a mold of the single piece of material. In some examples, the material may be stainless steel or other hard material suitable for forming the striking points 116a and 116b.

FIG. 2 is a front view of the multi-tool device 100 illustrating an example of the front surface 124 of the multi-tool device 100. FIG. 3 is a cross-sectional view of the multi-tool device through A/A′ of the multi-tool device 100 shown in FIG. 2. As shown in FIGS. 2 and 3, the utility holes 112a, 112b, and 112c, along with the opening 105 in the opener 104 extend completely through the multi-tool device 100. The magnet cavity 110 is formed within the handle 102, but does not extend through the handle 102 to facilitate receiving and securing a magnet. In addition, the area of utility hole 112c is greater than the area of utility holes 112a and 112b.

In the example shown in FIG. 3, the curved portion 123 of the claw 106 extends upward towards the front surface 124 of the handle 102. In addition, in the example shown in FIG. 2, the opening 122 within the claw 106 is formed substantially in the middle of the curved portion 123 of the claw 106.

As shown in FIG. 3, the male adaptor 108 extends below the back surface 126 of the handle 102 and is proximal to the claw 106. In addition, as can be seen in FIGS. 2 and 3, the ruler 114 on the handle 102 includes a plurality of indentations 300 on the front surface 124 of the handle 102 demarking units of distance. In the example shown in FIG. 2, the ruler 114 on the front surface 124 is a standard ruler for measuring inches.

In some examples, referring to FIG. 2, a length 202 of the multi-tool device 100 may be configurable to produce a desired form-factor of the multi-tool device. As an example, the length 202 of the multi-tool device 100 may be approximately 8 inches. In this example, a length 204 of the handle 102 may be approximately 5.75 inches, a length 206 of the opener 104 may be approximately 1.75 inches, and a length 208 of the claw 106 may be approximately 0.5 inches. In addition, a width 210 of the opener 104 may be approximately 3.5 inches, a width 212 of the opening 105 in the opener 104 may be approximately 2.35 inches, and a width 214 of the handle 102 may be approximately 0.75 inches.

Furthermore, referring to FIG. 3, a distance 302 between the male adaptor 108 and the claw 106 may be approximately 0.3 inches and a width 304 of the male adaptor 108 may be approximately 0.375 inches. In addition, a diameter 306 of the magnet cavity 110 may be approximately 00.50, a diameter 308 of utility holes 112a and 112b may be approximately 00.25, and a width 310 of utility hole 112c may be approximately 0.3 inches.

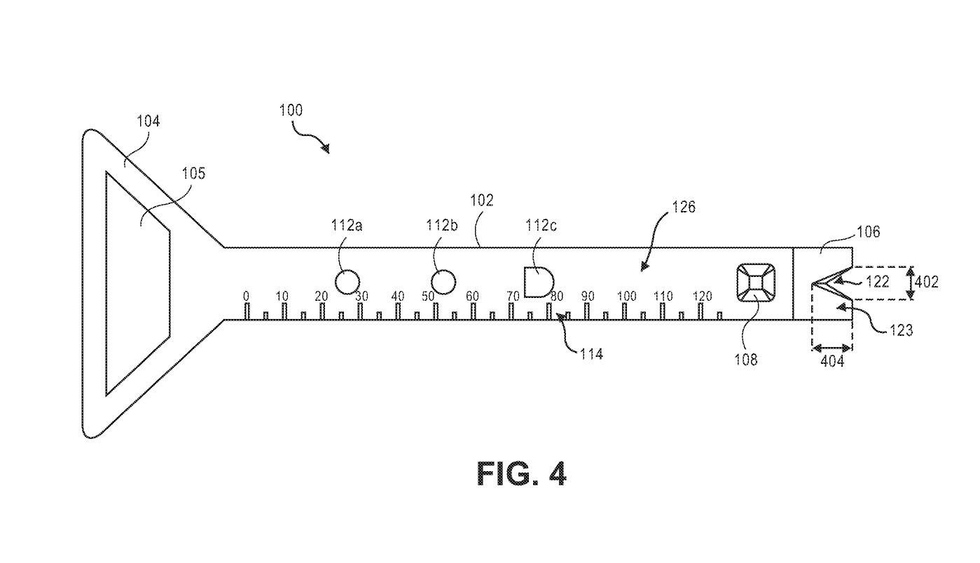

FIG. 4 is a back view of the multi-tool device 100 according to some aspects of the present disclosure. FIG. 4 illustrates an example of the back surface 126 of the multi-tool device 100. As shown in FIG. 4, the male adaptor 108 may have a substantially rectangular shape and may extend outward from the back surface 126 of the handle 102. The male adaptor 108 is also proximal to the claw 106. In addition, as can be seen in FIG. 4, the back surface 126 may have an additional ruler 114 on the handle 102. In the example shown in FIG. 4, the ruler 114 on the back surface 126 is a metric ruler for measuring millimeters and centimeters.

Furthermore, as shown in FIG. 4, the utility holes 112a, 112b, and 112c, along with the opening 105 in the opener 104, extend completely through the multi-tool device 100. However, since the magnet cavity does not extend through the handle, the magnet cavity is not visible from the back surface 126 of the multi-tool device 100.

In some examples, utilizing the dimensions given above with respect to FIGS. 2 and 3, a width 402 of the opening 122 in the claw 106 may be approximately 0.25 inches. In addition, a length 404 of the curved portion 123 of the claw 106 may be approximately 0.3 inches.

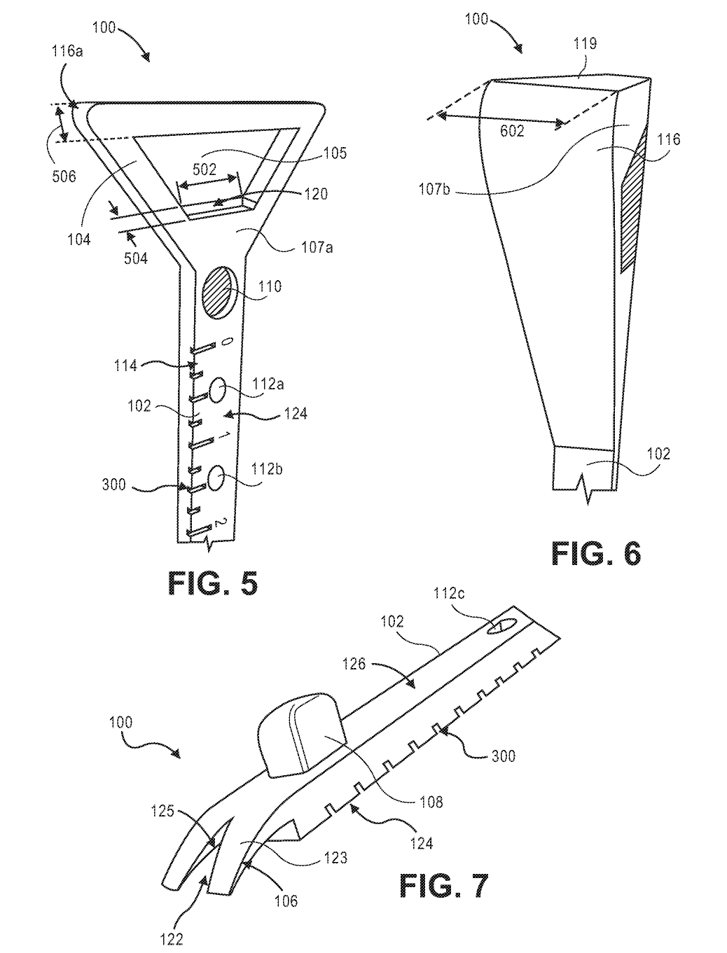

FIG. 5 is an expanded view of a portion of the multi-tool device according to some aspects of the present disclosure. In particular, FIG. 5 illustrates an expanded perspective view of the front surface 124 of the multi-tool device 100 that shows in more detail the external surface 120 of side 107a of the opener 104 facing the opening 105. In some examples, the external surface 120 may function as a pry ledge to remove caps or lids or to enable leverage to be applied to another object. In some examples, the pry ledge 120 may have a length 502 of approximately 1 inch and a width 504 of approximately 0.01 inches. In addition, one of the corners 116a of the opener 104 is illustrated in more detail in FIG. 5. In some examples, the corner 116a may have a width 506 of 0.25 inches.

The handle 102 including the magnet cavity 110, utility holes 112a and 112b and ruler 114 are further illustrated in FIG. 5. In addition, the indentions 300 in the front surface 124 of the handle 102 are illustrated wrapping around a portion of the side of the handle 102 to demark units of distance on the ruler 114.

FIG. 6 is an expanded view of another portion of the multi-tool device according to some aspects of the present disclosure. In particular, FIG. 6 illustrates an expanded perspective view of the opener 104 of the multi-tool device 100 that shows in more detail one of the corners 116a of the opener 104 and the external surface 119 of the side 107b of the opener 104. As indicated above, the corner 116a of the opener 104 may be a striking point (e.g., hammer or glass breaker) configured to strike another object. In addition, the external surface 119 of the side 107b may function as a scraper ledge that may be used to scrape, peel, or spread. In some examples, a width 602 of the scraper ledge 119 may be approximately 0.25 inches.

FIG. 7 is an expanded view of another portion of the multi-tool device according to some aspects of the present disclosure. In particular, FIG. 7 illustrates an expanded perspective view of the back surface 126 of the multi-tool device 100 that shows in more detail the claw 105, male adaptor 108 and indentions 300 of the ruler on the front surface 124 that wrap around the sides of the handle 102. The claw 106 includes the curved portion 123 that curves upward towards the front surface 124. In addition, the claw 106 is split down the middle to form the opening 122 and the cutter 125 is further formed on the inner surfaces of the opening 122 of the claw 106.

Several aspects of a multi-tool device have been presented with reference to an exemplary implementation. As those skilled in the art will readily appreciate, various aspects described throughout this disclosure may be extended to other configurations of a multi-tool device.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A multi-tool device, comprising:
a main body forming a handle;
an opener disposed at a first end of the handle, wherein the opener comprises an opening therein; and
a claw disposed at a second end of the handle, wherein the claw comprises a curved portion that is split down a middle of the curved portion to form an opening having a V-shape;
wherein the handle, the opening, and the claw comprise a single piece of material.

2. The multi-tool device of claim 1, further comprising:
a cutter disposed in the opening of the claw.

3. The multi-tool device of claim 1, further comprising:
a magnet cavity formed in a front surface of the handle, wherein the magnet cavity is configured to receive a magnet.

4. The multi-tool device of claim 1, further comprising:
a plurality of utility holes aligned along a length of the handle.

5. The multi-tool device of claim 1, further comprising:
a male adaptor disposed on a back surface of the handle.

6. The multi-tool device of claim 5, wherein the male adaptor is disposed proximal to the claw to provide leverage for the claw.

7. The multi-tool device of claim 1, further comprising:
a ruler formed within at least one surface of the handle.

8. The multi-tool device of claim 7, further comprising:
a plurality of indentions on the at least one surface of the handle demarking units of distance.

9. The multi-tool device of claim 7, wherein the ruler comprises:
a standard ruler formed within a front surface of the handle; and
a metric ruler formed within a back surface of the handle.

10. The multi-tool device of claim 1, wherein the handle comprises a rectangular shape and the opening comprises a trapezoid shape.

11. The multi-tool device of claim 10, wherein the opener comprises a set of parallel sides and a set of non-parallel sides, wherein a first side of the set of parallel sides is coupled to the handle and comprises a single external surface facing the opening.

12. The multi-tool device of claim 11, wherein the single external surface comprises a pry ledge.

13. The multi-tool device of claim 11, wherein a second side of the set of parallel sides is opposite the first side and separated from the first side by the opening, wherein the second side comprises an internal surface facing the opening and an external surface opposite the internal surface.

14. The multi-tool device of claim 13, wherein the external surface of the second side comprises a scraper ledge.

15. The multi-tool device of claim 12, wherein the opener further comprises a set of corners at respective ends of the second side.

16. The multi-tool device of claim 14, wherein each corner of the set of corners comprises a striking point configured to strike another object.

17. The multi-tool device of claim 1, wherein the handle, the opening, and the claw are collectively formed utilizing a mold of the single piece of material.
